(19) United States
(12) Patent Application Publication
(10) Pub. No.: US 2005/0027828 A1
(43) Pub. Date: Feb. 3, 2005

(54) Information distribution system, server, reading device, and display device

(75) Inventor: Yoshirou Yamazaki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/900,359

(22) Filed: Jul. 28, 2004

(30) Foreign Application Priority Data
Jul. 28, 2003 (JP) 2003-202270

(51) Int. Cl. G06F 15/16

(52) U.S. Cl. 709/219

(57) ABSTRACT

An information distribution system is chiefly constituted by an RF tag mounted to an article, a server, a display device, and a reading device. The RF tag stores article identification information that is unique to the article in a non-rewritable fashion. The reading device reads the instruction information from the RF tag, and sends the information to the server. The server stores and manages the article identification information and face image information of the owner of the article in association with each other. The server, based on the article identification information read by the reading device, retrieves the face image information of the owner, and sends the face image information to the display device. The display device, based on the face image information sent from the server, displays the face image as a visible image.

### BACKGROUND OF THE INVENTION

The present invention relates to an information distribution system for distributing information relating to the owner of an article, and more particularly to an information distribution system which enables easy and definite confirmation of who the proper owner is, for example, when handing over a lost article or the like, and a server, a reading device, and a display which device constitute such a system.

In order to secure the safety of sales transactions of articles and payment and the like performed when using a credit card, a mobile telephone, etc., various proposals have been made for systems in which a face image of a user is registered in a server (database) and the image is used for identify confirmation.

For example, JP 2002-95042 A discloses an identity confirmation system, in which information on a mobile telephone and a face photograph of an owner thereof are related to each other and registered into a database. When the mobile telephone accesses a central processing system, the central processing system searches and reads the face photograph of the owner of that mobile telephone from the database, and sends this to the mobile telephone. By displaying the face photograph on a display of the mobile telephone, identity confirmation can be performed without adding an IC chip or the like to the mobile telephone.

Furthermore, JP 2002-259868 A discloses a credit granting system in which, when registering a credit card, in addition to normal personal information, a face photograph of the card owner is registered into a database in association with the credit card number. When the card is used at a member store, a network device of the member store is used to reference the card number and retrieve the face photograph from the database via a communications network. The face photograph is received/displayed by the connecting system, and confirmation is made as to whether or not the user of the card is the proper owner.

Furthermore, JP 2002-279456 A does not relate to a credit card or mobile telephone, but discloses a data processor, where face data of a purchaser is recorded onto a season ticket having wireless communications means and storage means, and when the season ticket is delivered to a lost-and-found, or when a person appears and claims to be the owner of the season ticket, a picture of this person is taken to obtain face data, and the face data stored on the season ticket is read. The two are compared against each other to confirm whether or not the person is the purchaser of the season ticket.

According to those methods, the identity confirmation can be performed for a sales transaction or payment or the like if the purpose and referent are specific. However, the methods cannot handle various/diverse cases such as identity confirmation for multiple indeterminate articles, and identity confirmation in various instances where an article does not exist.

### SUMMARY OF THE INVENTION

An object of the present invention is to resolve the above-mentioned problems in the conventional techniques, and provide an information distribution system which can be used with multiple indeterminate articles and for various purposes and situations, to perform identity confirmation and personal information confirmation, and, for example, when processing lost-and-found articles and the like, enables identity confirmation to be performed surely and easily, and a server, a reading device, and a display device which constitute the information distribution system.

In order to attain the above-mentioned object, a first aspect of the present invention provides an information distribution system, comprising: a non-contact memory for being readable in a non-contact fashion and mounted to an article and stores unique article identification information about the article in a non-rewritable fashion; display devices having receiving means for receiving information, and display means for displaying the information received by the receiving means; a server having storage means for storing the article identification information in relation to face image information of an owner of the article, retrieval means for retrieving the face image information from the storage means based on the article identification information, and first transmitting means for transmitting the face image information retrieved by the retrieval means to the receiving means of the display device; and a reading device having reading means connected to the server for reading the article identification information stored in the memory, and second transmitting means for transmitting to the server the article identification information read by the reading means, wherein: the retrieval means retrieves the face image information of an owner of the article from the storage means based on the article identification information sent from the reading device; the first transmitting means transmits the face image information retrieved by the retrieval means and the article identification information to at least one display device selected from among the display devices; and the at least one display device displays the face image information as a visible image.

It is preferable that the reading device has obtaining means for obtaining designation information for designating from among the display devices, the at least one display device to which the face image information and the article identification information are to be transmitted, the second transmitting means transmits the designation information to the server, and the first transmitting means transmits the face image information and the article identification information to the at least one display device based on the designation information.

It is preferable that designation information for designating the at least one display device to which the face image information and the article identification information are to be transmitted is stored in the memory, read out by the reading means, and transmitted by the second transmitting means to the server, and the first transmitting means transmits the face image information and the article identification information to the at least one display device based on the designation information.

It is preferable that the designation information is stored in the memory.

It is preferable that the reading means includes reading unit for reading the article identification information stored in the memory and input unit for inputting the designation information; and the second transmitting means transmits the designation information inputted by the inputting means to the server.

It is preferable that the storage means stores owner information about the owner and article information about the article, in association with the article identification information; the owner information is at least one piece of information selected from the group consisting of a name of the owner, an address of the owner, a sex of the owner, an age of the owner, information which the owner remembers, and a characteristic of the owner; the article information is at least one piece of information selected from the group consisting of image information of the article, a name of the article, a weight of the article, and a size of the article; the first transmitting means transmits the face image information and at least one of the owner information and the article information to the display device based on the designation information; and the display device displays the face image information and at least one of the owner information and the article information.

It is preferable that the server controls the information transmitted to the display device based on control instructions which are set appropriately.

In order to attain the above-mentioned object, a second aspect of the present invention provides a server, comprising: storage means for storing the article identification information in relation to face image information of an owner of the article; retrieval means for retrieving the article identification information and the face image information stored in the storage means; transmitting means for transmitting the information to a display device; reading means for reading information from a non-contact memory for being readable in a non-contact fashion and mounted to the article and stores the unique article identification information in a non-rewritable condition; and receiving means for receiving information from a reading device having obtaining means for obtaining designation information designating the display device, wherein: the retrieval means for retrieving the face image information of the owner of the article from the storage means based on the article identification information received from the receiving means; and the transmitting means transmits the retrieved face image information to the display device based on the designation information.

In order to attain the above-mentioned object, a third aspect of the present invention provides a reading device, comprising: reading means for reading information from a non-contact memory for being readable in a non-contact fashion and mounted to an article and stores article identification information that is unique to the article in a non-rewritable condition; obtaining means for obtaining designation information designating a display device; and transmitting means that transmits the article identification information and the designation information to a server having storage means to be stored in association with face image information of an owner of the article.

In order to attain the above-mentioned object, a forth aspect of the present invention provides a display device, comprising: receiving means for receiving information; and display means for displaying the received information, wherein the display device is connected to a server storing the article identification information in relation to face image information of an owner of the article, and displays as a visible image the face image information provided from the server.

In order to attain the above-mentioned object, a fifth aspect of the present invention provides an information distribution system, comprising: a non-contact memory for being readable in a non-contact fashion and mounted to an article and stores unique article identification information about the article in a non-rewritable fashion; a server associating and storing the article identification information with an face image information of an owner of the article; display devices connected to the server; and a reading device connected to the server, having reading means for reading the article identification information stored in the memory and obtaining means for obtaining designation information designating a display device; wherein: the reading device transmits the article identification and the designation information to the server when the reading means reads the article identification information from the memory; the server retrieves an face image information the owner of the article based on the article identification information and transmits the retrieved face image information to the display device based on the designation information, the display device displays the face image information as a visible image.

As described above in detail, in accordance with the present invention, identity confirmation and personal information confirmation can be performed suitably for multiple indeterminate objects and in various purposes and situations. For example, when processing lost-and-found articles, identity confirmation can be performed reliably and easily.

Furthermore, in the information distribution system according to the present invention, the reading device for reading the article identification information, and the display device for displaying the face image information in relation to the article identification information, can be separated and installed at different locations. Accordingly, the face image information cannot be displayed at that place where the article identification information was read. This can prevent abuse of the personal information about the owner in relation to the article identification information.

This application claims priority on Japanese patent application No.2003-202270, the entire contents of which are hereby incorporated by reference.

### BRIEF DESCRIPTION OF THE DRAWING

In the accompanying drawing,

FIG. 1 is a conceptual diagram of an example of an information distribution system according to the present invention;

FIG. 2 schematically shows information stored in a storage unit of a server of the information distribution system of the present invention;

FIG. 3 is a block diagram of the server and a reading device in the information distribution system of the present invention and schematically shows how designation information stored in a predetermined storage area of the reading device is transmitted to the server; and

FIG. 4 is a block diagram showing the reading device, server and display device in the information distribution system of the present invention.

### DETAILED DESCRIPTION OF THE PREFERRED EMBODIMENT

Hereinafter, detailed explanation is given regarding an information distribution system, a server, a reading device, and a display device in accordance with the present invention, based on a preferred embodiment shown in the accompanying drawing.

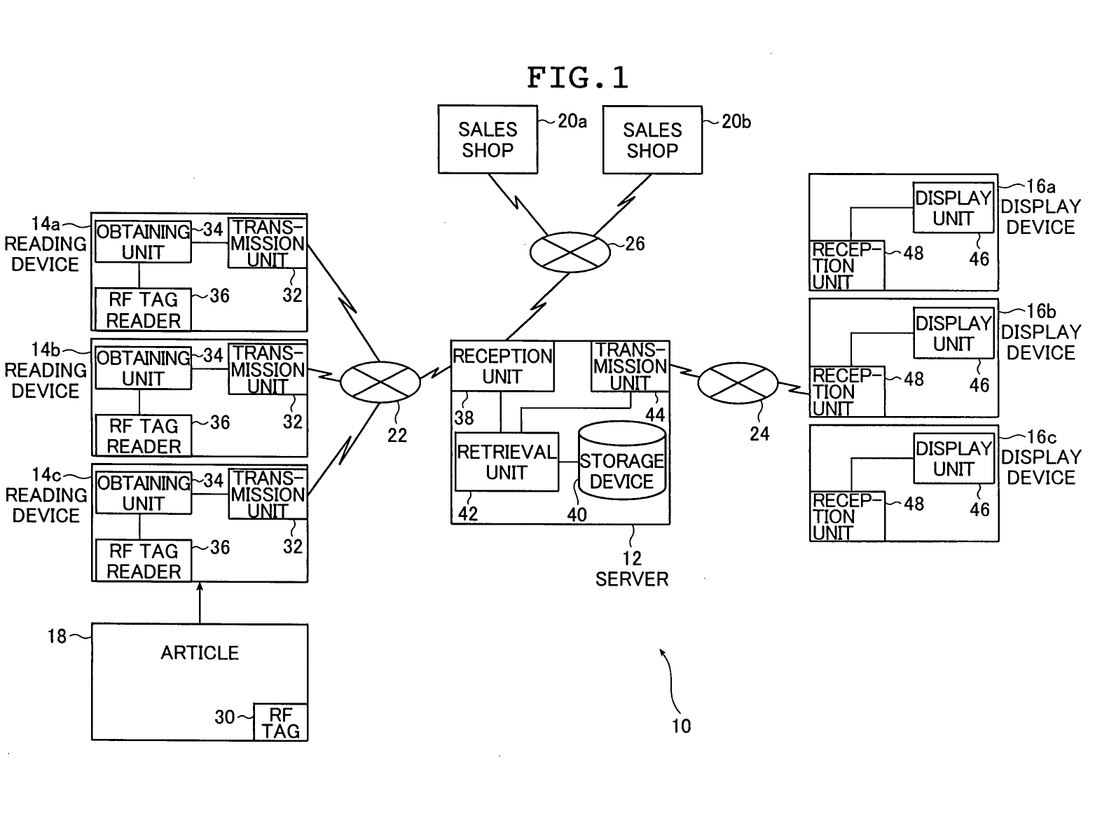

FIG. 1 shows a conceptual diagram of an example of the information distribution system according to the present invention.

An information distribution system 10 (hereinafter, referred to as “distribution system 10”) shown in FIG. 1 includes, basically, a server 12, a reading device 14 (reading devices 14a, 14b, and 14c), a display device 16 (display devices 16a, 16b, and 16c), and a sales shop 20 selling an article 18 constituting the present invention. The server 12, the reading device 14, and the display device 16 all pertain to the present invention.

Furthermore, the server 12 and the reading device 14 are connected via a communications network 22. The server 12 and the display device 16 are connected via a communications network 24. The server 12 and the sales shop 20 are connected via a communications network 26.

The communications networks used in the present invention are not particularly restricted, and various techniques may be used. For example, a computer communications network such as the Internet or a LAN (Local Area Network) may be used, or a dedicated network for sole use with the communications system 10 according to the present invention. A combination of those networks may also be used. Furthermore, the reading device 14, the display device 16, and the sales shop 20 may also be connected to the server 12 by a common communications network.

The article 18 constituting the communications system 10 according to the present invention may be furnished with an RF tag 30.

In the present invention, the article 18 is not particularly restricted. At present, the article 18 refers to any of articles which are circulated, sold, dealt with, lent, and the like in society.

Furthermore, the RF tag (IC tag) 30 has an IC chip or the like including an antenna, a memory, etc., and connects/communicates with a tag reader (tag reading means) wirelessly without contact. For example, an RFID (Radio Frequency IDentification) technology can be used. Note that, in the present invention, the memory furnished to various articles is not restricted to the RF tag 30. Various others are usable provided that they can be furnished to the article 18 and non-contact reading by the reading device 14 described below is possible.

Furthermore, the sales shop 20 is a normal sales shop that sells or rents the article 18 furnished with the RF tag 30. Note that, in the present invention, the sales shop 20 connected to the distribution system 10 is not restricted to the two shops as shown in the example in the diagram.

The RF tag 30 furnished to the article 18 stores unique identification information (hereinafter, called “article ID”) for identifying individual articles 18 in a non-rewritable condition.

Note that, the information stored in the RF tag 30 is not restricted to only the article ID. For example, the RF tag 30 may store instruction information for the display device 16 described below, information about the article 18 itself stored in the server 12 described below, and the like. Furthermore, those pieces of information may be unrewritable or rewritable, or a combination of both. However, the permanent information about the article's name and the like is preferably unrewritable.

The server 12, for example, is constituted by a computer, a workstation, or the like.

The server 12 is constituted by, for example, a storage unit 40 for storing information, a retrieval unit 42 for retrieving the information stored in the storage unit 40, a reception unit 38, and a transmission unit 44. The storage unit 40 can be constituted by, for example, a hard disk. In the storage unit 40, the article IDs of various articles, and the face photographs (face photograph image data) of the owners of the articles of the article IDs, are stored in association with one another. That is, in the storage unit 40, the article IDs and the face photograph of the owners of the articles indicated by the article IDs are accumulated into a database for management. Note that, in the present invention, the “owner” includes not only the person to whom the article 18 belongs (the person with right of ownership), but also a primary user, a person responsible for managing the article, and the like.

In the server 12, the transmission unit 44 transmits the information extracted by the retrieval unit 42 via the communications network 24 to a reception unit 48 of the display device 16. Furthermore, the reception unit 38 in the server 12 receives the information sent from the device furnished to the reading device 14 or at the sales shop 20. The information received at the reception unit 38 is accumulated in the storage unit 40.

Furthermore, at the server 12, the storage unit 40 preferably also stores, in association with the article ID and the like, one or more of various pieces of information pertaining to the owner of the article, such as an address, name, age, sex, telephone number, and e-mail address, (hereinafter, referred to generally as “owner information”), and/or one or more of various pieces of information pertaining to the article 18, such as a photograph or rendered image, name, weight, size, shape, and color (hereinafter, referred to generally as “article information”). Furthermore, as the owner information, in addition to the information pertaining to the individual owner such as described above, the nickname for the corresponding article, a password, a favorite word, the name of a relative, the birthplace of ancestors, and other such information which only the owner could know, that is which the owner remembers, are preferable. Furthermore, nervous jiggling, frequent eyelid movement, or other such habits, crouchback, a chicken breast, or other such visible characteristics, regional accents verbal tics, and other such information on characteristics which a third party can judge objectively, are preferable.

In particular, as the owner information, it is preferable to store the name, address, and information remembered by the owner in the server 12 storage unit. Furthermore, when the owner is a minor, information about a guardian (e.g., face image information or the above-mentioned owner information) is also preferably stored in the server 12 storage unit.

This information can be used to more preferably perform the confirmation of the person and the confirmation of the article 18 which are described below, to provide various pieces of information, to manage information about the owner in order to provide a service, and the like.

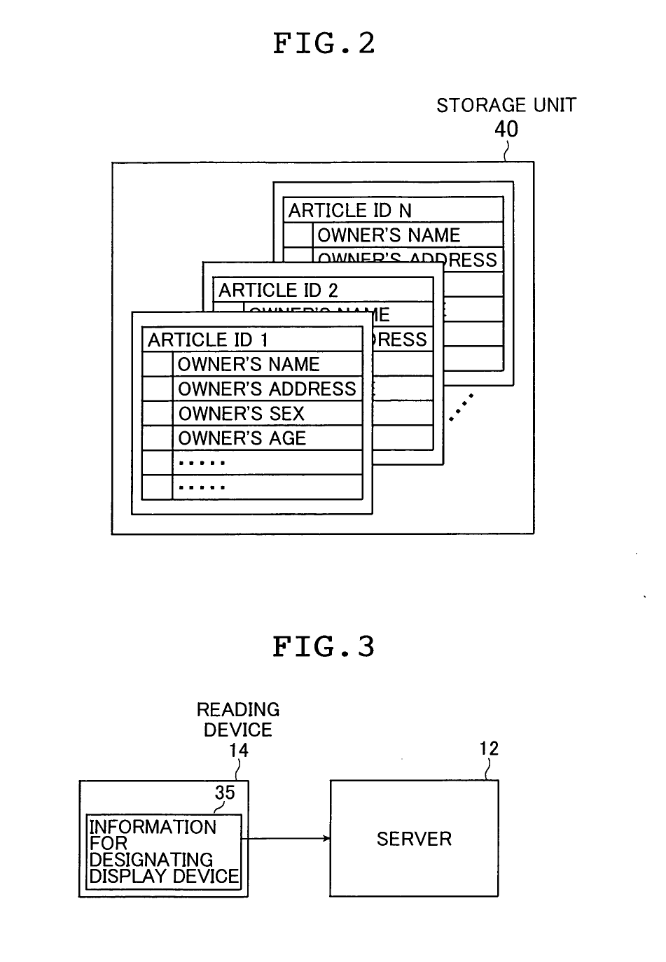

FIG. 2 schematically shows information stored in the storage unit 40 of the server 12. As shown in FIG. 2, one to N pieces (N: positive integer) of article ID information are stored in the storage unit 40 of the server 12 in relation to owner information including owner's name, address, sex, age and the like.

Furthermore, the retrieval unit 42 of the server 12 can retrieve the face photograph of the owner of the article from the various pieces of information stored in the storage unit 40, based on the article ID. The face photograph retrieved by the retrieval unit 42 is transmitted from the transmission unit 44 to the display device 16.

The reading device 14 has an RF tag reader 36 and a designated information obtaining unit 34. The RF tag reader 36 can read information from the RF tag 30 attached to the article 18. The designated information obtaining unit 34 can obtain designation information that designates which display device of the display devices 16a through 16cto send the information. The designated information obtaining unit 34, for example, can be constituted using selection means that uses, for example, a GUI (Graphical User Interface) for the user to select the display device 16 to which send the designated information is to be sent from the server 12.

This reading device 14 may be constituted using a computer or the like, for example.

Furthermore, the designated information obtaining unit 34, for example, may be constructed using an input device. In such a case, the user using the reading device 14 may input the designation information into the input device.

Here, the construction is provided with the designated information obtaining unit 34 for obtaining the designation information. However, when the designation information is stored in the RF tag 30, instead of providing the designated information obtaining unit 34, the designation information may be obtained by the RF tag reader 36.

In the present invention, the installation location of the reading device 14 is not particularly restricted. Installation is possible in a police box, a police station, a city hall or other such government office buildings, a train station, a department store or other such store buildings, a company or place of business, a theme park, a park, and other various places. Furthermore, the quantity of reading devices 14 constituting the present invention is not restricted to three as shown in the example in the diagram.

The display device 16 has the reception unit 48 and a display unit 46. The reception unit 48 can receive information sent from the server via the communications network 24. The display unit 46 can display information received by the reception unit 48. That is, the display unit 46 can display the face photograph sent from the server 12, and other various pieces of information sent simultaneously. This display device 16, similarly to the reading device 14, for example, may be constituted using a computer or the like. Furthermore, the installation is not restricted. Installation is possible at various locations. Furthermore, the quantity is not restricted to three as shown in the example in the diagram.

Hereinafter, processes of the distribution system 10 are explained to give more detailed explanation of the information distribution system according to the present invention.

As described above, for various types of articles 18, the server 12 stores the article ID in relation to the face photograph of the owner of the article indicated by the article ID, the owner information, the article information, and the like, to create a database.

For example, it is assumed here that a customer purchases the article 18 with the RF tag 30 at a sales shop 20a.

At the sales shop 20a, for example, a device constituted by a computer or the like connected to the server 12, is used to confirm whether or not the face photograph and the owner information of the customer have been stored in the server 12. In the case where they have already been stored, the RF tag 30 of the article 18 is read, an address, name, and other information for identifying the customer (hereinafter, called “customer identification information”) are inputted into a communications terminal or the like, and the article ID and the customer information, and other information stored in the RF tag 30 are related to one another and sent to the server 12 via the communications network 26.

On the other hand, in such cases where the customer first purchases the article 18 of the distribution system 10, there is no information in the server 12. Then, a face photograph is taken with the customer's permission and the customer provides owner information. The article ID, the face photograph, and the owner information are related to one another and sent to the server 12 via the communications network 26.

The server 12 uses the customer identification information that was sent to retrieve the information stored in the storage unit 40. In a case where an owner in relation to the customer identification information exists, the face photograph and the owner information of this owner are read out, and the provided article ID, face photograph, the owner information, and other information are related to one another and stored in the storage unit 40.

Furthermore, in the case where the article ID and also the face photograph, the owner information, or the like are sent, these are related to one another and stored in the storage unit 40. That is, the new owner is added to the registration in the storage unit 40.

Note that, in the present invention, the face photograph and/or the owner information may be provided beforehand from the customer, unique customer IDs may be set for each customer, and the customer ID, the face photograph, and the owner information may be related to one another and registered in the storage unit of the server 12 (or an other storage device).

In this embodiment, from the sales shop 20a, the article ID and the client ID (or other information as well) may be related to each other and sent. The server 12 may use the client ID to view the face photograph and the owner information, and the article ID, the face photograph, the owner information, the article information, and the like may be related to one another and stored in the storage unit 40 to create the database.

In the distribution system 10 according to the present invention, when distributing information, using the reading device 14c as an example, first the RF tag reader 36 of the reading device 14c reads the RF tag 30 of the article 18 pertinent to the distributed of information. Furthermore, the designation information obtaining means of the reading device 14c is used to obtain the designation information that instructs to send the information to the display device 16. Here, as an example, the instruction is to send the information to the display device 16b.

The instruction for the display device 16 of the reading device 14, for example, may be performed by a known method, similarly to the instruction, etc. instructing the destination to send information in various communications networks and the like. Furthermore, upon designation of the display device 16, when needed, the reading device 14 may query the server 12, obtain a list of the connected display devices, and display this list. Thus, the display device 16 to transmit the information may be selected from the list. Furthermore, a plurality of display devices 16 may be selected to give the instruction to send the information.

Note that, the reading device 14 is not restricted to selecting the display device 16 every time. For example, as long as no change is made, the previously selected display device 16 may be automatically designated as the sending destination.

Furthermore, depending on the reading device 14, and in accordance with the installation location of the distribution system 10 and the purposes of the user thereof, it is also possible as shown in FIG. 3, to preset fixed designation information in a predetermined storage area 35 and transmit the designation information on the display device 16 to the server 12, so that the information is always sent to the same display device 16. For example, an e-mail address and an IP address may be used for the designation information. Such designation information may be rewritable.

When predetermined operations end, the reading device 14c may associate the article ID read from the RF tag 30 and the instruction information to send the information to the display device 14b, and send these from the transmission unit 32 to the server 12. Note that the reading device 14c, as needed, transmits to the sever 12 the other information read from the RF tag 30.

At the server 12, the reception unit 38 receives the article ID and the instruction information transmitted from the reading device 14c, and then the retrieval unit 42 uses the article ID to search the storage unit 40. If this article ID is under management of the sever 12, then the face photograph of the owner, the owner information, the article information, and the like which are related to the article ID are read out. Note that, not all pieces of the owner information and the article information have to be read. For example, the article information may not be read, or the like. The information to be read out may be selected as needed.

Next, the server 12 transmits the information read from the storage unit 40 such as the face photograph of the owner, the owner information, and the article information, to the designated display device 16b from the transmission unit 44.

The display device 16b to which the information was sent displays the face photograph on a display, and also displays on the display various pieces of information that was sent.

Using the distribution system 10 according to the present invention enables identification of the owner of lost-and-found articles and forgotten articles, cross-referencing of the identity of the owner of the article, and the like. That is, depending on various kinds of articles, the usage of the distribution system 10, and various circumstances, the owner of the article can be identified, the identity of the person can be confirmed, and the like.

For example, it is assumed here that the display device 16a is installed at a police station, and the reading device 14a is installed at a police box in the same jurisdiction. A third party who picked up the article 18 attached with the RF tag 30 takes the article to the police box where the reading device 14a is installed. On the other hand, a person who claims to have dropped the article 18 appears at the police station where the display device 16a is installed.

In response to a query from the police station, the reading device 14a at the police box reads the article's RF tag 30, and also inputs the display device 16a installed at the police station as the destination to send the information. When the predetermined processing ends, the reading device 14a associates the article ID read from the RF tag and the instruction information that instructs to send to the display device 16a, and transmits these to the server 12.

The server 12 uses the article ID to perform a search. If the information corresponding to the article ID is under its management, then the face photograph and the owner information are read, and this information is transmitted to the display device 16a at the police station as in the sending instructions.

The display device 16a receives the information and displays the face photograph of the owner and the owner information as a visible image. Therefore, at the police station, the face photograph and the owner information can be viewed, and confirmation can be made regarding whether or not the person claiming to have dropped the article is the owner of the article 18. Furthermore, after confirming the identity, instructions can be given to go receive the article at the police box where the reading device 14a is installed.

At this time, there could be a case where the reading device 14 is installed in the vicinity of the display device 16a, and the person claiming to have dropped the article owns another article attached with the RF tag 30.

In this case, preferably, the reading device 14 reads the RF tag 30 of the article that the person owns, i.e., the article of which the owner is self-evident, the server 12 transmits the face photograph and the owner information to the display device 16a, and by displaying these on the display device 16a, more certain identification of the individual is performed.

Furthermore, the RF tag 30 is furnished to a wristwatch, a ring, or other article 18 which is constantly worn, the reading device 14 is installed to an entrance/exit of a building, a door of a room, or the like, and the display device 16 is installed at a building management center, an event management center, or the like:

Accordingly, the face, identity, and the like of the person inside the building can be learned, to perform management of building safety, management of personnel entering and exiting, accumulation of information about event participants, and the like.

Furthermore, in a case where the display device 16 according to the present invention is used at a sales shop or the like in a department store or the like, for example, the reading device 14 may be installed at an entrance to the shop or to gates that are arranged at locations in the shop, and the display device 16 may be installed behind counters on each sales floor or at the management center. Accordingly, it is possible to perform accumulation of customer information, for example, the date/time and frequency of the customers' visits to the store, research on merchandise of interest to the customers, a sales record, items frequently worn by the customers, and other such information. Furthermore, on the sales floor, it is possible to learn the identity of customers visiting the store, and the like. By using the accumulated information and the like, more detailed service and the like can be performed.

In the distribution system 10 according to the present invention, there is a high possibility that the server 12 (database) stores, in addition to the face photograph of the owner, the owner's address, name, age, and other various personal information. However, depending on the type of the article 18, the installation location of the display device 16, the usage of the distribution system 10 from the perspective of the owner, and the method of using the distribution system 10, and the like, there are many cases where not all the information should be shown, or where it is more preferable not to display all the information due to security reasons.

Therefore, in the distribution system 10 according to the present invention, the information sent from the server 12 to the display device 16 is preferably limited as needed.

As an example, levels for transmitting information may be set, such as a level A permitting transmission of all information, a level B permitting transmission of only essential information, a level C permitting transmission of only the face photograph and the name, and so on. Which display device 16 corresponds to which level may be determined in advance, and the server 12 may transmit only the allowed information to the display device 16, whereby the information that is transmitted may be limited.

Furthermore, the information that is allowed to be sent may be inputted into the RF tag 30, whereby the information sent from the server 12 to the display device 16 may be limited as needed. Note that, in any of these methods, the levels as mentioned above may be set and used.

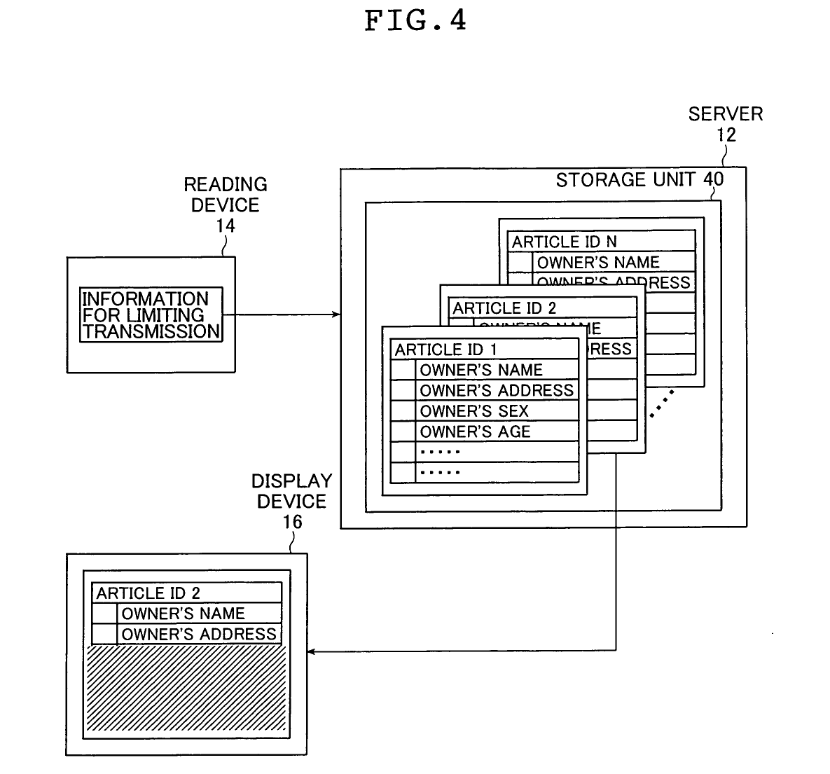

Alternatively, at the reading device 14, when giving the instruction for the display device 16, the information that is allowed to send may be inputted, and the information sent from the server 12 to the display device 16 may be limited as needed. FIG. 4 schematically shows an exemplary case where information to be transmitted from the server 12 to the display device 16 is limited so that the other information than the owner's name and address cannot be transmitted. Information for limiting the transmission to the display device 16 is inputted in the reading device 14. The limitation information is transmitted from the reading device 14 to the server 12. The server 12 retrieves an article ID and transmits the article ID and the owner information limited by the limitation information to the display device 16 designated by designation information. In this example, the article ID and the owner's name and address are only transmitted to the display device 16 so that the article ID and the limitation information (i.e., owner's name and address) are only displayed on the display unit 46 of the display device 16.

Information for limiting the display on the display unit 46 (hereinafter referred to as “display limiting information”) may be used instead of the information for limiting the transmission. In this case, the server 12 only has to transmit to the display device 16 the display limiting information inputted from the reading device 14 together with the article ID and the owner information. The display device 16 only has to display on the display unit 46 the other information than the information limited on the owner.

In the distribution system 10 according to the present invention, the face photograph was transmitted to the display device 16, as necessary information. Here, after a long period of time elapses from the day when the owner is registered in the distribution system 10, there are cases where the face changes due to aging, the owner moves or marries, or the like. In such cases, there is a possibility that proper confirmation cannot be performed.

Therefore, in the distribution system 10 according to the present invention, preferably, the server 12 calculates the elapsed time from the time of registration to the time of transmitting, and then transmits this elapsed time together with the face photograph and the like.

Furthermore, in the case where the change occurs in the information about the owner due to moving and the like, this information is preferably collected and the information stored in the server is updated. Furthermore, regular confirmations and the like are preferably performed to update the face photograph and the information about the registrant.

The detailed explanation has been given above regarding the distribution system according to the present invention and the server, reading device, and display device that constituted the server. However, the present invention is not restricted to the above-mentioned embodiment. Of course, various modifications and improvements can be made without departing from the scope of the gist of the present invention.

For example, in the distribution system 10 shown in the example in the diagrams, the sales shop 20 and the server 12 are connected by the communications network 26, but the present invention is not necessarily limited to this configuration. For example, in order for a sales shop 20 in a department store or the like to perform customer services and customer management, when the distribution system according to the present invention is set up only within the shop, the server 12 may be installed in the sales shop 20 and the operator or the like may manipulate the server 12 to input/store therein various pieces of information described below.

Furthermore, in the distribution system 10 in the example in the diagram, the article ID is stored in association with the face photograph, the owner information, the article information, and the like, which are at a lower level, thus constituting the database. However, the present invention is not restricted to this configuration.

For example, the face photograph, the owner information, and the like may be provided and registered in the distribution system 10 according to the present invention by a user beforehand. A unique registrant ID may be set for the user, and this registrant ID may be placed at the topmost level. In association with the registrant ID, the face photograph, the article ID of the article owned by the owner (the registered user), the owner information, the article information, and the like may be stored, thus constituting the database.

1. An information distribution system, comprising:
a non-contact memory for being readable in a non-contact fashion and mounted to an article and stores unique article identification information about the article in a non-rewritable fashion;
display devices having receiving means for receiving information, and display means for displaying the information received by said receiving means;
a server having storage means for storing the article identification information in relation to face image information of an owner of the article, retrieval means for retrieving the face image information from said storage means based on the article identification information, and first transmitting means for transmitting the face image information retrieved by said retrieval means to said receiving means of said display device; and
a reading device having reading means connected to said server for reading the article identification information stored in said memory, and second transmitting means for transmitting to said server the article identification information read by said reading means, wherein:
said retrieval means retrieves the face image information of an owner of the article from said storage means based on the article identification information sent from said reading device;
said first transmitting means transmits the face image information retrieved by said retrieval means and the article identification information to at least one display device selected from among said display devices; and
said at least one display device displays the face image information as a visible image.

2. The information distribution system according to claim 1, wherein said reading device has obtaining means for obtaining designation information for designating from among said display devices, said at least one display device to which said face image information and said article identification information are to be transmitted, said second transmitting means transmits said designation information to said server, and said first transmitting means transmits said face image information and said article identification information to said at least one display device based on said designation information.

3. The information distribution system according to claim 1, wherein designation information for designating said at least one display device to which said face image information and said article identification information are to be transmitted is stored in said memory, read out by said reading means, and transmitted by said second transmitting means to said server, and said first transmitting means transmits said face image information and said article identification information to said at least one display device based on said designation information.

4. The information distribution system according to claim 1, wherein the designation information is stored in said memory.

5. The information distribution system according to claim 1, wherein:
said reading means includes reading unit for reading the article identification information stored in said memory and input unit for inputting the designation information; and
said second transmitting means transmits the designation information inputted by said inputting means to said server.

6. The information distribution system according to claim 1, wherein:
said storage means stores owner information about the owner and article information about the article, in association with the article identification information;
said owner information is at least one piece of information selected from the group consisting of a name of the owner, an address of the owner, a sex of the owner, an age of the owner, information which the owner remembers, and a characteristic of the owner;
said article information is at least one piece of information selected from said group consisting of image information of the article, a name of the article, a weight of the article, and a size of the article;
said first transmitting means transmits the face image information and at least one of the owner information and the article information to said display device based on the designation information; and
said display device displays the face image information and at least one of the owner information and the article information.

7. The information distribution system according to claim 6, wherein said server controls the information transmitted to said display device based on control instructions which are set appropriately.

8. A server, comprising:
storage means for storing the article identification information in relation to face image information of an owner of the article;
retrieval means for retrieving the article identification information and the face image information stored in said storage means;
transmitting means for transmitting the information to a display device;
reading means for reading information from a non-contact memory for being readable in a non-contact fashion and mounted to the article and stores the unique article identification information in a non-rewritable condition; and
receiving means for receiving information from a reading device having obtaining means for obtaining designation information designating said display device, wherein:
said retrieval means for retrieving the face image information of the owner of the article from said storage means based on the article identification information received from said receiving means; and
said transmitting means transmits the retrieved face image information to said display device based on the designation information.

9. A reading device, comprising:
reading means for reading information from a non-contact memory for being readable in a non-contact fashion and mounted to an article and stores article identification information that is unique to the article in a non-rewritable condition;
obtaining means for obtaining designation information designating a display device; and
transmitting means that transmits the article identification information and the designation information to a server having storage means to be stored in association with face image information of an owner of the article.

10. A display device, comprising:
receiving means for receiving information; and
display means for displaying the received information,
wherein the display device is connected to a server storing the article identification information in relation to face image information of an owner of the article, and displays as a visible image the face image information provided from the server.

11. An information distribution system, comprising:
a non-contact memory for being readable in a non-contact fashion and mounted to an article and stores unique article identification information about the article in a non-rewritable fashion;
a server storing said article identification information in relation to an face image information of an owner of said article;
display devices connected to said server; and
a reading device connected to said server, having reading means for reading said article identification information stored in said memory and obtaining means for obtaining designation information designating a display device; wherein:
said reading device transmits said article identification and said designation information to said server when said reading means reads said article identification information from said memory;
said server retrieves an face image information the owner of the article based on the article identification information and transmits the retrieved face image information to said display device based on said designation information,
said display device displays the face image information as a visible image.
